(19) United States
(12) Patent Application Publication
(10) Pub. No.: US 2008/0044208 A1
(43) Pub. Date: Feb. 21, 2008

(54) IMAGE FORMING DEVICE

(75) Inventor: Koichi MOTOYOSHI, Kyoto-shi (JP)

Correspondence Address: MURATA MACHINERY, LTD.;(MURATEC) c/o KEATING & BENNETT LLP, 8180 GREENSBORO DRIVE, SUITE 850, MCLEAN, VA, 22102, US

(73) Assignee: MURATA KIKAI KABUSHIKI KAISHA, Fushimi-ku (JP)

(21) Appl. No.: 11/835,479

(22) Filed: Aug. 8, 2007

(30) Foreign Application Priority Data
Aug. 21, 2006 (JP) 2006-224680

(51) Int. Cl. G03G 21/00

(52) U.S. Cl. 399/376

(57) ABSTRACT

In an image forming device, on a farther end side from each paper guide of a manual paper feed tray, a pair of protruding portions are arranged such that each of the protruding portions is arranged on either side to prevent oblique movement of papers. One of the protruding portions is provided with a paper setting dial rotatably attached thereto. Marks indicating a paper size are displayed on a circumferential surface of the dial such that the size can be set by turning the dial in accordance with the size of the placed paper. The paper setting dial is attached on a side on which a user stands when placing the papers.

### BACKGROUND OF THE INVENTION

1. Field of the Invention

The present invention relates to an image forming device such as a copier, a facsimile machine, and a printer.

2. Description of the Related Art

An image forming device which uses a photoconductive drum, for example, as an image carrier, charges and exposes a surface of the photoconductive drum to form an electrostatic latent image, visualizes the electrostatic latent image by adhering toner to the image, and transfers the adhered toner to a paper, is known as an electrophotographic image forming device. In such an image forming device, image forming processing is performed by transporting papers of various sizes, and the papers of a frequently-used size are placed in a paper feed cassette and fed to the image forming device. However, when using cardboard or the like, which cannot be fed easily from the paper feed cassette, the image forming processing is performed by feeding such materials from a manual paper feed tray.

When using the papers of various sizes, it is necessary to perform image processing in accordance with a size of the fed paper. Therefore, the image processing is performed by detecting the size of the paper placed in the paper feed cassette.

For example, a conventional paper feed cassette includes a configuration in which a switch-and-set dial having a display mark indicating the size of the papers accommodated in an accommodating portion of the paper feed tray is turned and switched, and the paper feed tray is placed in a housing. In the above-described paper feed cassette, when a type and a size indicated by a turned position of the switch-and-set dial are detected by a type-and-size detection sensor, the paper size is determined. In addition, the conventional paper feed cassette includes a configuration in which a paper size setting dial arranged at a front edge of a box of the paper feed tray protrudes upward from the box when the box is drawn out, and makes contact with a front surface of a device main body when the box is inserted.

In the above-described conventional paper feed cassette, a set dial displaying the size of the papers placed in the paper feed tray is provided to prompt a user to check the paper size. In addition, the set dial is provided to prevent image processing using a paper of a different size. However, the paper size used in the image processing is generally displayed at an operation display panel unit arranged on an upper portion of the device. Therefore, a problem is that it is difficult to check whether or not the paper size displayed at the operation display panel unit matches the paper size displayed on the paper feed cassette that is positioned apart from the operation display panel unit.

In particular, when feeding the paper from the manual paper feed tray on which various papers are to be placed, it is difficult to check whether or not the size of the placed paper matches the paper size set at the operation display panel unit. In such a case, problems such as a jam may occur when placing the paper on the manual paper feed tray without checking the paper size set at the operation display panel unit.

### SUMMARY OF THE INVENTION

In order to overcome the problems described above, preferred embodiments of the present invention provide an image forming device in which it is easy to check whether or not a size of papers placed on a manual paper feed tray matches a paper size set at an operation display panel unit. Further, it becomes possible to reliably set the paper size without forgetting the setting.

An image forming device according to a preferred embodiment of the present invention includes the manual paper feed tray, a paper setting dial, a paper size detection unit, and a control unit. The manual paper feed tray is provided in a device main body for feeding the papers manually such that the manual paper feed tray can be opened and closed. The paper setting dial is rotatably arranged on a paper placing surface side of the manual paper feed tray and displays the paper size. The paper size detection unit detects a set position of the paper setting dial. The control unit performs paper transportation control based on a detection signal from the paper size detection unit. Moreover, when an open-close detection sensor of the manual paper feed tray detects an opened status, the control unit performs the paper transportation control based on the detection signal from the paper size detection unit. Further, the paper setting dial is arranged to have a color different from a color of the manual paper feed tray. Furthermore, the paper setting dial on the manual paper feed tray is arranged on a front surface side of the device.

With the above-described configuration, the size can be set by using the paper setting dial attached to the manual paper feed tray. Moreover, a size setting operation can be easily carried out while checking the placed paper, and the setting is reliably carried out. When the placed paper matches the size set at the paper setting dial, information on the size of the placed paper is reliably output by the paper size detection unit to the device main body, and thus, a paper transporting operation can be stably carried out.

When the open-close detection sensor of the manual paper feed tray detects the opened status, the paper transportation control is performed based on the detection signal from the paper size detection unit. In the above-described configuration, only under a state in which the manual paper feed tray is under the opened status and the paper can be fed manually, paper transportation can be carried out based on the detection signal from the paper size detection unit. Thus, a manual paper feeding operation can be reliably carried out.

Since the paper setting dial is arranged to have a color different from the color of the manual paper feed tray, a user can easily view and check the paper setting dial, and consequently, the setting operation of the paper size is prompted when the paper is placed on the manual paper feed tray.

Further, the paper setting dial can be arranged on the front surface side of the device, i.e., on a side on which the user stands when placing the papers on the manual paper feed tray. Accordingly, the paper setting dial can be easily viewed and checked when placing the paper, and the setting will not be forgotten.

Other features, elements, processes, steps, characteristics and advantages of the present invention will become more apparent from the following detailed description of preferred embodiments of the present invention with reference to the attached drawings.

### BRIEF DESCRIPTION OF THE DRAWINGS

FIG. 1 is a schematic sectional view of an overall image forming device according to preferred embodiments of the present invention.

FIG. 2 is an enlarged partial perspective view illustrating a state in which a manual paper feed tray is positioned at an open position.

FIG. 3 is an enlarged perspective view of a portion to which a paper setting dial is attached.

FIG. 4 is a schematic block diagram illustrating paper feeding control when feeding papers manually.

### DETAILED DESCRIPTION OF PREFERRED EMBODIMENTS

A detailed description will be made of preferred embodiments of the present invention. Since the preferred embodiments described below are preferred specific examples of the present invention, the preferred embodiments may have various technical limitations. However, the present invention is not limited to the preferred embodiments as long as it is not specified in the following description that the present invention is limited to the preferred embodiments.

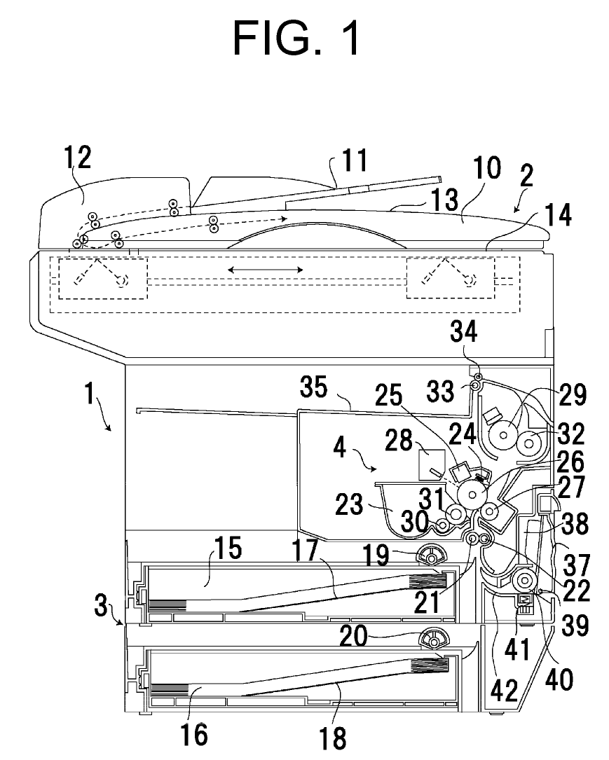

FIG. 1 is a schematic sectional view of an overall image forming device according to preferred embodiments of the present invention. An original document scanning unit 2 is arranged on an upper portion of an image forming device 1. A paper feeding unit 3 and a recording unit 4 are subsequently arranged from a bottom surface on a lower portion of the image forming device 1.

At the original document scanning unit 2, an original document placed on an original document tray 11 mounted on an original document cover 10 is transported by an original document transporting device 12 to a position opposite an original document scanning portion, scanned, and discharged onto an original document discharge tray 13. When scanning a book, etc., the original document cover 10 is opened upward, a portion to be scanned of the book, etc., is arranged on a flatbed platen 14, and a scanning operation is carried out at the scanning portion. The above-described configuration is similar to a configuration of a conventional original document scanning device including an Auto Document Feeder (an ADF) and a flatbed.

In the paper feeding unit 3, paper feed cassettes 15 and 16 are vertically arranged and accommodate a plurality of papers of a prescribed size stacked on respective flappers 17 and 18. The flappers 17 and 18 are axially supported at a left end portion in FIG. 1 by a hinge. Pick up rollers 19 and 20 are arranged on a right side in FIG. 1. The flappers 17 and 18 are biased upward so that an upper surface of the stacked papers makes contact with the corresponding pick up rollers 19 or 20. Under such a state, when the pick up roller 19 or 20 is rotationally driven, the papers are fed to the paper transportation path one sheet at a time by frictional force.

The fed paper is transported by a feed roller 21 and a pressing roller 22 to the recording unit 4. In order to record an image on the transported paper, the recording unit 4 includes a toner container 23, a memory removing brush 24, a charger 25, a photoconductive drum 26, a transfer roller 27, an exposure head 28, and a fuser roller 29. First, a surface of the photoconductive drum 26 is uniformly charged by using the charger 25. Then, by exposing the charged photoconductive drum 26 with the exposure head 28 according to an image recording signal, an electrostatic latent image is formed. Next, toner inside the toner container 23 is transferred from a supply roller 30 to the electrostatic latent image formed on the photoconductive drum 26 via a developing roller 31 and is visualized. Next, a toner image formed on the surface of the photoconductive drum 26 is transferred to the paper by the transfer roller 27. Then, the transferred toner image is fixed to the paper by being heated and pressed by the fuser roller 29 and a pressing roller 32. The fixed paper is nipped between a discharge roller 33 and a pressing roller 34 and discharged onto a paper discharge tray 35.

On a side surface of the image forming device 1, a manual paper feed tray 37 is arranged at an accommodating open portion 38. In FIG. 1, the manual paper feed tray 37 is positioned at a closed position by being latched to a device main body by a latching member (not illustrated), however, the manual paper feed tray 37 can turn to an opened position by being axially supported by a turning shaft 39. A pick up roller 40 and a pad 41 pressed against the pick up roller 40 are arranged on a lower portion of the accommodating open portion 38 so as to transport a manually fed paper. When the pick up roller 40 is rotated, the manually fed paper is transported along a guide 42 to a portion between the feed roller 21 and the pressing roller 22.

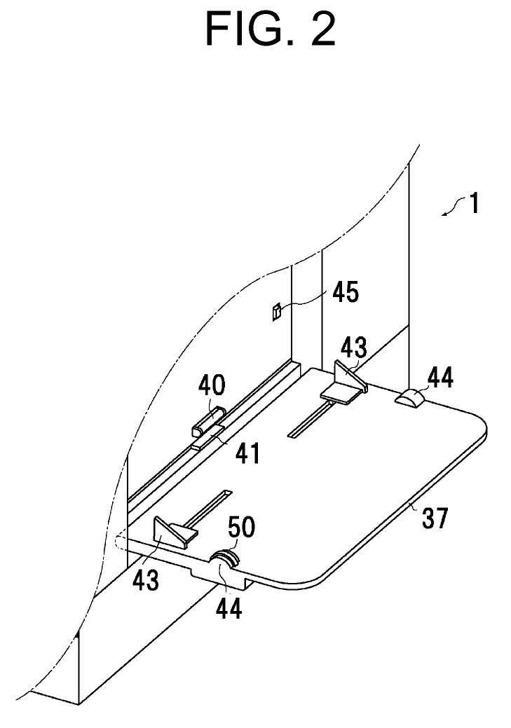

FIG. 2 is an enlarged partial perspective view illustrating a state in which the manual paper feed tray 37 is positioned in the open position. An upper surface of the manual paper feed tray 37 is a paper placing surface. A pair of paper guides 43 are arranged on an upper surface of the manual paper feed tray 37 such that each of the paper guides 43 is arranged on either side of the upper surface. The pair of paper guides 43 are attached such that each of the paper guides 43 can move from respective side end portions towards a central portion by fitting to respective linear grooves formed in the upper surface. An interlock mechanism (not illustrated) is provided inside the manual paper feed tray 37 such that when one of the guides 43 is moved along the groove, the other guide 43 moves accompanying the one guide 43. Therefore, by placing the paper between the pair of paper guides 43 and moving the paper guides 43 such that the paper guides 43 make contact with respective side ends of the paper, the paper can be placed on a position in accordance with the paper size.

On an end side farther from the paper guide 43 on the manual paper feed tray 37, a pair of protruding portions 44 are arranged such that each of the protruding portions 44 is arranged on either side to prevent oblique movement of the paper when feeding the paper. A paper setting dial 50 is rotatably attached to one of the protruding portions 44. By attaching the paper setting dial 50 on a front surface side of the device, i.e., on a side on which the user stands when placing the paper, the user can easily operate, view, and check the paper setting dial 50. Therefore, a setting operation will not be forgotten.

An open-close detection sensor 45 for detecting an opening and a closing of the manual paper feed tray 37 is arranged at the accommodating open portion 38 on a device main body side. Accordingly, when the manual paper feed tray 37 is closed in the accommodating open portion 38, an actuating bar (not illustrated) of the open-close detection sensor 45 is pressed by the manual paper feed tray 37, and the open-close detection sensor 45 is turned off. When the manual paper feed tray 37 is turned and opened, the actuating bar of the open-close detection sensor 45 is released from the pressed state and turned on.

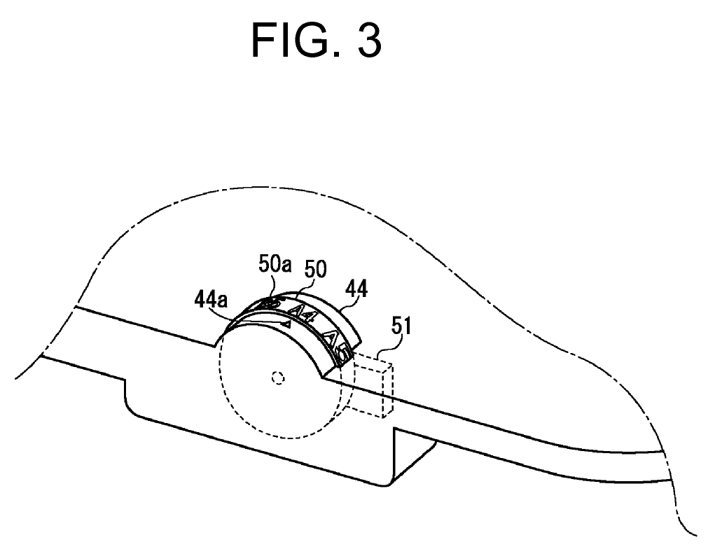

FIG. 3 is an enlarged perspective view of a portion to which the paper setting dial 50 is attached. The protruding portion 44 has an arc shape in its sectional view and protrudes in a curved shape. Moreover, a central portion of the protruding portion 44 is cut away for a prescribed width, and the disk-shaped paper setting dial 50 is inserted into the cut-away portion and axially and rotatably supported. Marks indicating a size of the paper are displayed around a circumferential surface of the paper setting dial 50. In this example, marks 50a such as “B5”, “A4”, “B4”, and “A3” are displayed.

A regulation unit (not illustrated) is arranged such that the paper setting dial 50 can be turned by a predetermined angle according to an interval between the marks 50a displayed on the circumferential surface. As the regulation unit, for example, holes may be formed with an interval of a predetermined angle therebetween in a circumferential direction, and an elastic member formed with a protrusion may be arranged to be fitted in the hole. Thus, by turning the paper setting dial 50 manually, the paper setting dial 50 can be turned by a predetermined angle.

On an outer surface of the protruding portion 44, a triangular instruction mark 44a is engraved in the vicinity of the paper setting dial 50. When setting the size of the paper placed on the manual paper feed tray 37, the paper setting dial 50 is manually turned so that the instruction mark 44a points to a mark 50a that indicates the appropriate size.

When the paper setting dial 50 is arranged to have a color different from a color of the protruding portion 44, the user can easily view and check the paper setting dial 50. Moreover, it becomes unnecessary to check whether or not the appropriate paper size is set at the operation display panel when the paper is placed on the manual paper feed tray 37. In addition, the setting operation will not be forgotten. For example, when the protruding portion 44 has a light color, it is more preferable to arrange the paper setting dial 50 to have a deep color so that a contrast will be readily apparent.

A paper size detection sensor 51 arranged to detect the position of the paper setting dial 50 is provided inside the protruding portion 44. The paper size detection sensor 51 may optically detect the position by using a reflection portion or a through hole formed on a side surface of the paper setting dial 50, or may electrically detect the position by attaching a conductive material to the side surface. Thus, a detection signal corresponding to the paper size mark 50a pointed to by the instruction mark 44a is output by the paper size detection sensor 51.

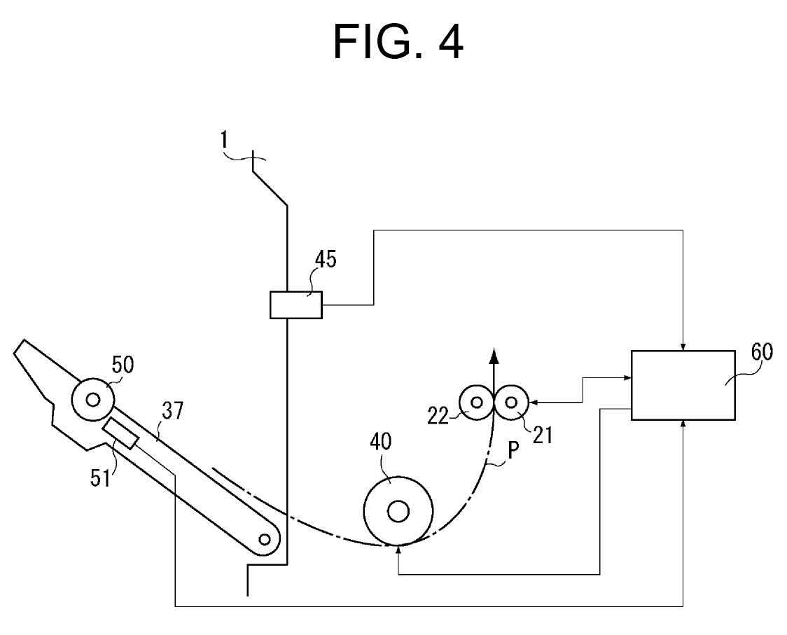

FIG. 4 is a schematic block diagram illustrating paper feeding control when feeding the paper manually. A control unit 60, which controls a manual paper feeding operation, is connected to the open-close detection sensor 45 that detects the opening and the closing of the manual paper feed tray 37 and to the paper size detection sensor 51. The detection signal from each of the detection sensors is input into the control unit 60.

When the manual paper feed tray 37 is closed and the open-close detection sensor 45 is turned off, the control unit 60 does not perform control of manual paper feeding but performs control of paper feeding from the usual paper feed cassette. When the manual paper feed tray 37 is opened, the open-close detection sensor 45 is turned on, and the control unit 60 checks the detection signal from the paper size detection sensor 51 based on the detection signal from the open-close detection sensor 45. When the paper setting dial 50 is turned by the user to be set at a prescribed size, the detection signal corresponding to the paper size is input into the control unit 60, and data about the paper size is registered.

When a printing command is input from the operation display panel of the device main body, the control unit 60 starts rotating the pick up roller 40 and performs the manual paper feeding operation. The manually fed paper P is transported between the feed roller 21 and the pressing roller 22. Thus, image forming processing is carried out at the recording unit 4 in accordance with the registered paper size.

As described above, the size of the paper that is manually fed by the user can be easily set by the paper setting dial attached to the manual paper feed tray. Further, when placing the paper, the paper setting dial is viewed and checked, and the setting operation of the paper size is reliably carried out.

While the present invention has been described with respect to preferred embodiments thereof, it will be apparent to those skilled in the art that the disclosed invention may be modified in numerous ways and may assume many embodiments other than those specifically set out and described above. Accordingly, the appended claims are intended to cover all modifications of the present invention that fall within the true spirit and scope of the present invention.

What is claimed is:

1. An image forming device comprising:
a manual paper feed tray arranged to manually feed paper, the manual paper feed tray arranged to be opened and closed;
a paper setting dial rotatably attached to a paper placing surface of the manual paper feed tray, the paper setting dial being arranged to display a paper size;
a paper size detection sensor arranged to detect a position of the paper setting dial; and
a control unit arranged to perform paper transportation control based on a detection signal from the paper size detection sensor.

2. The image forming device according to claim 1, wherein the control unit performs the paper transportation control based on the detection signal from the paper size detection sensor when an open-close detection sensor of the manual paper feed tray detects that the manual paper feed tray is opened.

3. The image forming device according to claim 1, wherein the paper setting dial has a color that is different from a color of the manual paper feed tray.

4. The image forming device according to claim 3, wherein the paper setting dial has a dark color and the manual paper feed tray has a light color.

5. The image forming device according to claim 3, wherein the paper setting dial is located on a device front surface side of the manual paper feed tray.

6. The image forming device according to claim 4, wherein the paper setting dial is located on a device front surface side of the manual paper feed tray.
